(19) United States
(12) Patent Application Publication
(10) Pub. No.: US 2026/0171663 A1
(43) Pub. Date: Jun. 18, 2026

(54) ANTENNA AND COMMUNICATION DEVICE

(71) Applicant: HUAWEI TECHNOLOGIES CO., LTD., Shenzhen (CN)

(72) Inventors: Chengdai Xue, Dongguan (CN); Zhijie Zhang, Dongguan (CN); Zijing Du, Xi'an (CN); Can Wang, Dongguan (CN); Yipeng Fan, Dongguan (CN)

(73) Assignee: HUAWEI TECHNOLOGIES CO., LTD., Shenzhen (CN)

(21) Appl. No.: 19/535,860

(22) Filed: Feb. 10, 2026

Related U.S. Application Data
(63) Continuation of application No. PCT/CN2024/107938, filed on Jul. 26, 2024.

(30) Foreign Application Priority Data
Aug. 11, 2023 (CN) 202311015408.1

(51) Int. Cl. H01Q 1/52; H01Q 1/24; H01Q 15/24; H01Q 19/10

(52) U.S. Cl. CPC H01Q 1/521; H01Q 1/246; H01Q 15/24; H01Q 19/10

(57) ABSTRACT

This application relates to the field of communication technologies, and provides an antenna and a communication device, to resolve a problem of mutual coupling between radiators in the antenna. The antenna provided in this application includes a first radiation assembly and a second radiator. An operating frequency band of the first radiation assembly is greater than an operating frequency band of the second radiator. The first radiation assembly may include a first radiator and a first director. A resonant frequency of the first radiator is greater than or equal to 0.4F₀ and less than or equal to 0.6F₀. The first director is located in a radiation direction of the first radiator and coupled to the first radiator.

### CROSS-REFERENCE TO RELATED APPLICATIONS

This application is a continuation of International Application No. PCT/CN2024/107938, filed on Jul. 26, 2024, which claims priority to Chinese Patent Application No. 202311015408.1, filed on Aug. 11, 2023. The disclosures of the aforementioned applications are hereby incorporated by reference in their entireties.

### TECHNICAL FIELD

This application relates to the field of communication technologies, and in particular, to an antenna and a communication device.

### BACKGROUND

With rapid development of wireless communication technologies, the industry's demand for antenna-system capacity continuously rises. To increase a data transmission rate and a channel capacity of the antenna system, a growing number of radiators are arranged in an antenna. During actual application, a plurality of radiators are deployed densely in an antenna, and some of the radiators have distinct operating frequency bands, which can cause inter-band interference between radiators. For example, high-frequency antennas are coupled to low-frequency antennas. This coupling degrades signal transmission performance and coverage capabilities of the antenna. Therefore, how to reduce interference between radiators becomes a technical problem to be urgently resolved.

### SUMMARY

This application provides an antenna and a communication device that have good operating performance.

According to a first aspect, this application provides an antenna. The antenna may include a first radiation assembly and a second radiator. An operating frequency band of the first radiation assembly is greater than an operating frequency band of the second radiator. The first radiation assembly may include a first radiator and a first director. A resonant frequency of the first radiator is greater than or equal to 0.4F₀ and less than or equal to 0.6F₀. The first director is located in a radiation direction of the first radiator and coupled to the first radiator. A resonant frequency of the first director is greater than or equal to 0.4F_{L} and less than or equal to 0.6F_{L}. F₀ is a center frequency of the first radiation assembly, and F_{L} is a minimum operating frequency of the first radiation assembly. In the antenna provided in this application, the minimum operating frequency of the first radiation assembly can be achieved by using the first director, so that adverse impact on operating performance of the second radiator caused by coupling between the first radiator and the second radiator can be effectively reduced.

In an example, the first radiation assembly may further include a second director. The second director is located in the radiation direction of the first radiator and coupled to the first radiator. A resonant frequency of the second director is greater than or equal to 0.4F_{H} and less than or equal to 0.6F_{H}. F_{H} is a maximum operating frequency of the first radiation assembly. The second director is disposed, so that the maximum operating frequency of the first radiation assembly can be achieved, to help increase bandwidth of the first radiation assembly.

In a specific configuration, the first radiator has a radiation surface, and an aperture of the radiation surface may be greater than or equal to 0.25λ₀*0.25λ₀ and less than or equal to 0.35λ₀*0.35λ₀. In addition, a height of the radiator in the radiation direction may be less than or equal to 0.2λ_{L}. λ₀ is a wavelength of an electromagnetic wave at the center operating frequency of the first radiation assembly when the electromagnetic wave propagates in free space, and λ_{L} is a wavelength of an electromagnetic wave at the minimum operating frequency of the first radiation assembly when the electromagnetic wave propagates in free space. The resonant frequency of the first radiator can be near the center frequency of the first radiation assembly by using the foregoing structure configuration, so that radiation performance of the first radiation assembly can be ensured.

In a specific configuration, the radiation surface may have a vertical arm that extends perpendicular to the radiation surface, and a length of the vertical arm is 0.05λ₀. λ₀ is the wavelength of the electromagnetic wave at the center operating frequency of the first radiation assembly when the electromagnetic wave propagates in free space. The vertical arm is disposed, so that the aperture of the radiation surface can be further reduced, and a size of the first radiator in a direction parallel to the radiation surface can be reduced, to arrange more first radiators in the antenna.

In an example, the first radiator may have a first polarized radiation arm and a second polarized radiation arm that are orthogonally disposed. The first director may have a slot, and the slot is provided corresponding to the first polarized radiation arm or the second polarized radiation arm. A length of the slot is greater than or equal to 0.15λ_{H} and less than or equal to 0.25λ_{H}. λ_{H} is a wavelength of an electromagnetic wave at the maximum operating frequency of the first radiation assembly when the electromagnetic wave propagates in free space. The slot may effectively improve isolation of the first radiation assembly in different polarizations, to ensure performance of the first radiation assembly.

In an example, the second director may include a rectangular substrate and a plurality of rectangular sheets, the rectangular substrate has a first plate surface, and the plurality of rectangular sheets are distributed on the first plate surface. A ratio of a width to a length of the rectangular substrate is greater than or equal to 0.6 and less than 1. In summary, the rectangular substrate has an asymmetric structure, so that isolation of the first radiation assembly in different polarizations can be effectively improved, to ensure performance of the first radiation assembly.

In a specific configuration, a size of each of the rectangular sheets may be 0.06λ₀*0.045λ₀. λ₀ is a wavelength of an electromagnetic wave at the center operating frequency of the first radiation assembly when the electromagnetic wave propagates in free space.

In addition, the plurality of rectangular sheets may be asymmetrically distributed on the first plate surface, so that isolation of the first radiation assembly in different polarizations can be effectively improved, to ensure performance of the first radiation assembly.

In an example, the second director further has a plurality of decoupling strips, and the plurality of decoupling strips are all located on the first plate surface and disposed along an edge of the first plate surface. A ratio of a shortest decoupling strip to a longest decoupling strip among the plurality of decoupling strips is greater than or equal to 0.7 and less than 1. Decoupling strips of different lengths are disposed, so that isolation of the first radiation assembly in different polarizations can be effectively improved, to ensure performance of the first radiation assembly.

In a specific configuration, the plurality of decoupling strips may include a decoupling strip with a length of 0.2λ₀ and a decoupling strip with a length of 0.25λ₀.

In an example, the antenna may further include a reflective plate and a balun structure. The reflective plate has a reflective surface and a back surface that is away from the reflective surface. The first radiation assembly and the second radiator are both located on the reflective surface. The back surface of the reflective plate has a feeding cavity. The balun structure includes a first feeding plate and a second feeding plate. The first feeding plate has a first segment and a second segment, and an included angle that is in a direction parallel to the reflective surface and that is between the first segment and the second segment is 45°. The second feeding plate has a third segment and a fourth segment, and an included angle that is in the direction parallel to the reflective surface and that is between the third segment and the fourth segment is 45°. The first segment and the third segment are orthogonally disposed, and the second segment and the fourth segment are disposed in mirror symmetry. Both the first segment and the second segment are feed-connected to the first radiation assembly, and an end portion of the third segment and an end portion of the fourth segment extend into the feeding cavity.

In an example, the antenna may further include a feeding network, and the feeding network is located in the feeding cavity. The feeding network has a first feeding probe and a second feeding probe. The end portion of the third segment has a first arc-shaped arm, and an outer arc surface of the first arc-shaped arm abuts against the first feeding probe. The end portion of the fourth segment has a second arc-shaped arm, and an outer arc surface of the second arc-shaped arm abuts against the second feeding probe.

According to a second aspect, this application further provides a communication device, including a radio frequency processing unit and the foregoing antenna. The antenna includes the feeding network, the radio frequency processing unit, and the feeding network. The feeding network is configured to send a feeding signal to a radiation assembly, or a radio signal received by the radiation assembly may be transmitted to the feeding network through a coupling structure and a balun structure. The radio frequency processing unit may be configured to perform frequency selection, amplification, and down-conversion processing on a signal received by the antenna. In the communication device provided in this application, the foregoing antenna is used, so that manufacturing costs and material use costs can be effectively reduced, and signal transmission performance is good.

### BRIEF DESCRIPTION OF DRAWINGS

FIG. 1 is a diagram of an application scenario of an antenna according to an embodiment of this application;

FIG. 2 is a diagram of a structure of a base station according to an embodiment of this application;

FIG. 3 is a block diagram of a structure of an antenna according to an embodiment of this application;

FIG. 4 is a diagram of a structure of a side surface of an antenna according to an embodiment of this application;

FIG. 5 is a diagram of a three-dimensional structure of a first radiator of an antenna according to an embodiment of this application;

FIG. 6 is a diagram of a planar structure of a first director of an antenna according to an embodiment of this application;

FIG. 7 is a diagram of a three-dimensional structure of an antenna according to an embodiment of this application;

FIG. 8 is a schematic exploded view of a structure of an antenna according to an embodiment of this application;

FIG. 9 is a diagram of a three-dimensional structure of a balun structure according to an embodiment of this application;

FIG. 10 is a diagram of a structure of a side surface of a partial structure of an antenna according to an embodiment of this application;

FIG. 11 is a diagram of a three-dimensional structure of another antenna according to an embodiment of this application;

FIG. 12 is a diagram of a planar structure of a second director of an antenna according to an embodiment of this application;

FIG. 13 is a diagram of a cross-sectional structure of an antenna according to an embodiment of this application;

FIG. 14 is a graph of radiation gain versus frequency for a polarization of a second radiator according to an embodiment of this application;

FIG. 15 is a graph of radiation gain versus frequency for another polarization of a second radiator according to an embodiment of this application;

FIG. 16 is a radiation pattern of a second radiator according to an embodiment of this application;

FIG. 17 is another radiation pattern of a second radiator according to an embodiment of this application;

FIG. 18 is another radiation pattern of a second radiator according to an embodiment of this application; and

FIG. 19 is a block diagram of a structure of a communication device according to an embodiment of this application.

### DESCRIPTION OF EMBODIMENTS

To make the objectives, technical solutions, and advantages of this application clearer, the following further describes this application in detail with reference to the accompanying drawings.

An antenna provided in embodiments of this application may be used in a communication device like a base station or a radar, to implement a wireless communication function.

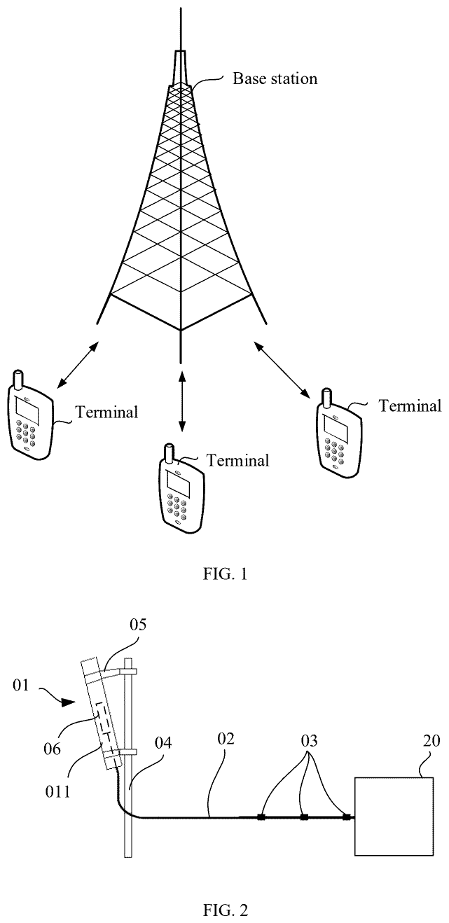

As shown in FIG. 1, an application scenario may include a base station and a terminal. Wireless communication may be implemented between the base station and the terminal. The base station may be located in a base station subsystem (base station subsystem, BBS), a terrestrial radio access network (UMTS terrestrial radio access network, UTRAN), or an evolved universal terrestrial radio access network (evolved universal terrestrial radio access network, E-UTRAN), and is configured to provide cell coverage of a radio signal, to implement communication between a terminal device and a wireless network. Specifically, the base station may be a base transceiver station (base transceiver station, BTS) in a global system for mobile communications (global system for mobile communications, GSM) or a code division multiple access (code division multiple access, CDMA) system, may be a NodeB (NodeB, NB) in a wideband code division multiple access (wideband code division multiple access, WCDMA) system, may be an evolved NodeB (evolved NodeB, eNB, or eNodeB) in a long term evolution (long term evolution, LTE) system, or may be a radio controller in a cloud radio access network (cloud radio access network, CRAN) scenario. Alternatively, the base station may be a relay station, an access point, a vehicle-mounted device, a wearable device, a gNodeB (gNodeB or gNB) in a new radio (new radio, NR) system, a base station in a future evolved network, or the like. This is not limited in embodiments of this application.

As shown in FIG. 2, a base station provided in embodiments of this application includes a base station antenna feeder system. During actual application, the base station antenna feeder system mainly includes an antenna 01, a feeder 02, a grounding apparatus 03, and the like. The antenna 01 is generally fastened on a pole 04, and a downtilt of the antenna 01 may be adjusted by using an antenna adjustment mounting bracket 05, to adjust a signal coverage area of the antenna 01 to some extent.

In addition, the base station may further include a radio frequency processing unit 06 and a baseband processing unit 20. For example, the radio frequency processing unit 06 may be configured to: perform frequency selection, amplification, and down-conversion processing on a signal received by the antenna 01; convert the signal into an intermediate frequency signal or a baseband signal; and send the intermediate frequency signal or the baseband signal to the baseband processing unit 20. Alternatively, the radio frequency processing unit 06 is configured to: perform up-conversion and amplification processing on an intermediate frequency signal sent by the baseband processing unit 20; convert the intermediate frequency signal into a radio signal through the antenna 01; and send the radio signal. The baseband processing unit 20 may be connected to a feeding network of the antenna 01 through the radio frequency processing unit 06. In some implementations, the radio frequency processing unit 06 may also be referred to as a remote radio unit (remote radio unit, RRU), and the baseband processing unit 20 may also be referred to as a baseband unit (baseband unit, BBU).

As shown in FIG. 2, in a possible embodiment, the radio frequency processing unit 06 may be integrated with the antenna 01, the baseband processing unit 20 is located at a remote end of the antenna 01, and the radio frequency processing unit 06 may be connected to the baseband processing unit 20 through the feeder 02. In another embodiment, both the radio frequency processing unit 06 and the baseband processing unit 20 may be located at a remote end of the antenna 01.

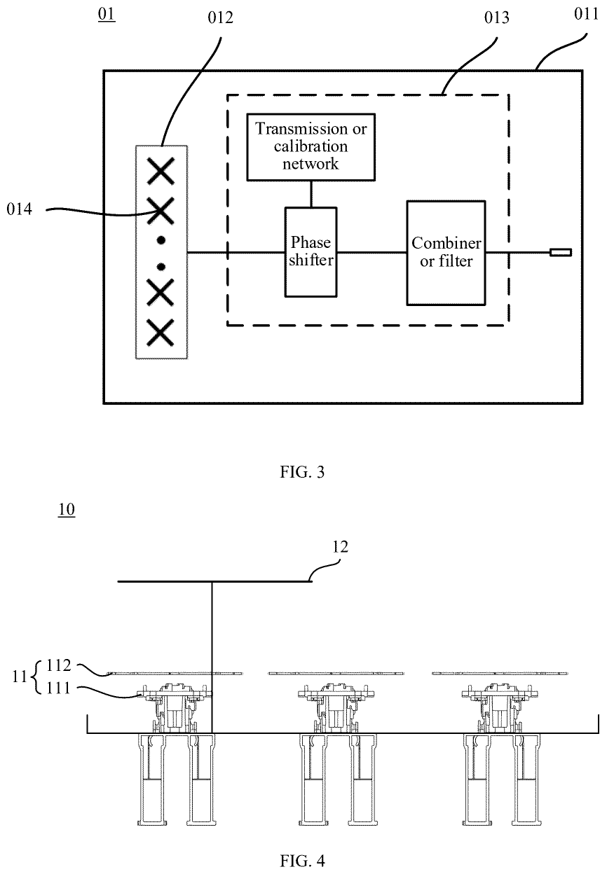

Refer to FIG. 2 and FIG. 3. The antenna 01 used in the base station may further include a radome 011, and a reflective plate 012 and a feeding network 013 that are located in the radome 011. The reflective plate 012 may also be referred to as a bottom plate. A main function of the feeding network 013 is to feed a signal to a radiation assembly 014 based on a specific amplitude and phase, or send a radio signal received by the radiation assembly 014 to the baseband processing unit 20 of the base station based on a specific amplitude and phase. It may be understood that, in a specific implementation, the feeding network 013 may include at least one of devices such as a phase shifter, a combiner, a transmission or calibration network, or a filter. Components and types of the feeding network 013 and functions that can be implemented by the feeding network 013 are not limited in this application.

Certainly, the antenna 01 may be further used in a plurality of other types of communication devices. An application scenario of the antenna 01 is not limited in this application.

For the radome 011, in terms of electrical performance, the radome 011 has good electromagnetic wave penetrability, so that normal sending and receiving of an electromagnetic wave between the radiation assembly 014 and the outside are not affected. In terms of mechanical performance, the radome 011 has good force-bearing performance and anti-oxidation performance, so that the radome 011 can withstand corrosion of an external harsh environment.

The radiation assembly 014 may include one or more radiators. The radiator may also be referred to as a radiation element. The radiator or the radiation element is a unit that forms a basic structure of the radiation assembly 014, and can effectively transmit or receive an electromagnetic wave. When the radiation assembly 014 includes a plurality of radiators, the plurality of radiators may form an array for use. During specific application, the radiation assembly may be classified into a single-polarized radiation assembly, a dual-polarized radiation assembly, or the like. In a specific configuration, a type of the radiation assembly may be appropriately selected based on an actual requirement.

With continuous development of mobile communication technologies, a 5th generation mobile communication technology (5th generation mobile communication technology, 5G) is also widely applied. As one of key technologies of a 5G communication system, a massive multiple-input multiple-output (multiple-input multiple-output, MIMO) technology can effectively increase a channel capacity. In a background of the massive multiple-input multiple-output technology, a large quantity of radiators need to be arranged in an antenna. In addition, with a miniaturization design, a distance between radiation elements is generally small, so that coupling is likely to occur between different radiators. For example, when an antenna includes a first radiator and a second radiator that operate in different frequency bands, and an operating frequency band of the first radiator is greater than an operating frequency band of the second radiator, during operation of the second radiator, the second radiator induces, on the first radiator, an induced signal in the operating frequency band of the second radiator. Re-radiation of the induced signal on the first radiator interferes with an electromagnetic wave generated by the second radiator, resulting in adverse impact such as signal distortion and degraded radiation pattern integrity. Therefore, reducing coupling between radiators is crucial to a design of a massive array antenna.

Therefore, embodiments of this application provide an antenna with good operating performance.

To make the objectives, technical solutions, and advantages of this application clearer, the following further describes this application in detail with reference to the accompanying drawings and specific embodiments.

As shown in FIG. 4, in an example provided in this application, an antenna 10 may include a first radiation assembly 11 and a second radiator 12. An operating frequency band of the first radiation assembly 11 is greater than an operating frequency band of the second radiator 12. The first radiation assembly 11 includes a first radiator 111 and a first director 112, and a resonant frequency of the first radiator 111 is greater than or equal to 0.4F₀ and less than or equal to 0.6F₀. The first director 112 is located in a radiation direction of the first radiator 111 and coupled to the first radiator 111. A resonant frequency of the first director 112 is greater than or equal to 0.4F_{L} and less than or equal to 0.6F_{L}. The first radiator 111 is coupled to the first director 112, so that the first radiator 111 can excite the first director 112 to radiate an electromagnetic wave. F₀ is a center frequency of the first radiation assembly 11, and F_{L} is a minimum operating frequency of the first radiation assembly 11.

It should be noted that the center frequency F₀ of the first radiation assembly 11 refers to a center point between the minimum frequency and the maximum frequency in the operating frequency band of the first radiation assembly 11. The operating frequency band of the first radiation assembly 11 is F_{L} to F_{H}, the minimum operating frequency of the first radiation assembly 11 is F_{L}, the maximum operating frequency of the first radiation assembly 11 is F_{H}, and the center frequency F₀ of the first radiation assembly 11 is (F_{L}+F_{H})/2. For example, if the operating frequency band of the first radiation assembly 11 may be 1.7 GHz to 2.7 GHz, the center frequency of the first radiation assembly 11 is 2.2 GHz.

In the antenna 10 provided in this application, the minimum operating frequency of the first radiation assembly 11 can be achieved by using the first director 112, so that adverse impact on operating performance of the second radiator 12 caused by coupling between the first radiator 111 and the second radiator 12 can be effectively reduced.

For ease of understanding of the technical solutions of this application, the following first describes a specific case of the first radiator 111 and the second radiator 12 when the first radiation assembly 11 only includes the first radiator 111.

When the first director 112 is not disposed, the first radiator 111 independently implements a radiation function of the first radiation assembly 11. An operating frequency band of the first radiator 111 is the operating frequency band of the first radiation assembly 11. Therefore, to enable the operating frequency band of the first radiation assembly 11 to be F_{L} to F_{H}, the resonant frequency of the first radiator 111 needs to be near the minimum frequency F_{L}. For example, the resonant frequency of the first radiator 111 may be greater than or equal to 0.4F_{L} and less than or equal to 0.6F_{L}. The resonant frequency of the first radiator 111 is related to a direct current path of the first radiator 111, and the direct current path is related to parameters such as a radiation surface aperture and a height of the first radiator 111. When the resonant frequency of the first radiator 111 decreases, the direct current path of the first radiator 111 becomes longer, and the parameters such as the radiation aperture and the height of the first radiator 111 become larger. During operation of the second radiator 12, the second radiator 12 is likely to induce, on the first radiator 111, an induced signal near the operating frequency band of the second radiator 12. Re-radiation of the induced signal on the first radiator 111 interferes with an electromagnetic wave generated by the second radiator 12, resulting in adverse impact such as signal distortion and degraded radiation pattern integrity.

However, when the direct current path of the first radiator 111 is shorter and the parameters such as the radiation aperture and the height of the first radiator 111 are larger, during operation of the second radiator 12, a frequency of the induced signal induced on the first radiator 111 by the second radiator 12 is higher. Because the operating frequency band of the second radiator 12 is less than the operating frequency band of the first radiator 111, the frequency of the induced signal is also higher than the operating frequency band of the second radiator 12, to reduce impact of the induced signal on the second radiator 12.

Therefore, in the example provided in this application, the resonant frequency of the first radiator 111 is increased from a value near the minimum frequency F_{L} to a value near the center frequency F₀. In other words, the resonant frequency of the first radiator 111 may be increased from a range greater than or equal to 0.4F_{L} and less than or equal to 0.6F_{L} to a range greater than or equal to 0.4F₀ and less than or equal to 0.6F₀. F₀ is greater than F_{L}. After the resonant frequency of the first radiator 111 increases, during operation of the second radiator 12, the frequency of the induced signal induced on the first radiator 111 by the second radiator 12 is higher, so that operating performance of the second radiator 12 can be ensured. In addition, after the resonant frequency of the first radiator 111 increases, a size of the first radiator 111 is reduced, so that more first radiators 111 can be arranged in the antenna 10.

In addition, when the first director 112 is not disposed on the first radiation assembly 11, after the resonant frequency of the first radiator 111 increases, the minimum operating frequency in the operating frequency band of the first radiation assembly 11 also increases. Therefore, in the example provided in this application, to ensure the minimum operating frequency of the first radiation assembly 11, the first director 112 with a low resonant frequency is disposed. The first director 112 is coupled to the first radiator 111, so that an electromagnetic wave generated by the first radiator 111 can generate an induced current in the first director 112, and re-radiation of the induced current occurs in the first director 112, so that an electromagnetic wave in a low frequency band can be output, and bandwidth performance of the entire first radiation assembly 11 can be effectively ensured.

During specific application, the first radiator 111 and the second radiator 12 may be of currently commonly used types such as a dual-polarized type and a single-polarized type. Details are not described herein.

For ease of understanding of the technical solutions of this application, the following uses an example in which the first radiator 111 is a dual-polarized radiator for detailed descriptions.

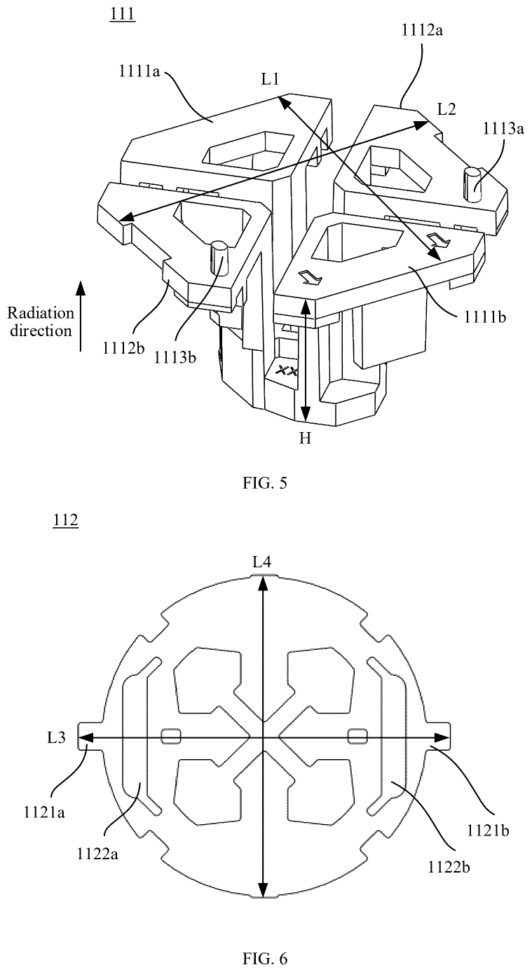

As shown in FIG. 5, in an example provided in this application, the first radiator 111 includes a first polarized radiation arms 1111a and a first polarized radiation arm 1111b that are disposed opposite to each other, and a second polarized radiation arm 1112a and a second polarized radiation arm 1112b that are disposed opposite to each other. The first polarized radiation arms 1111a and 1111b are disposed orthogonally to the second polarized radiation arms 1112a and 1112b.

The first radiator 111 has a surface that is in a radiation direction and that is a radiation surface. In a specific configuration, to enable the resonant frequency of the first radiator 111 to fall within the range greater than or equal to 0.4F₀ and less than or equal to 0.6F₀, an aperture L1*L2 of the radiation surface may be greater than or equal to 0.25λ₀*0.25λ₀ and less than or equal to 0.35λ₀*0.35λ₀, and the height H of the radiator in the radiation direction may be less than or equal to 0.2λ_{L}. λ₀ is a wavelength of an electromagnetic wave at the center operating frequency of the first radiation assembly 11 when the electromagnetic wave propagates in free space, and λ_{L} is a wavelength of an electromagnetic wave at the maximum operating frequency of the first radiation assembly 11 when the electromagnetic wave propagates in free space.

Certainly, in another example, parameters such as the radiation surface aperture and the height of the first radiator 111 may be appropriately set based on an actual situation. Details are not described herein.

In addition, as shown in FIG. 5, in the example provided in this application, the radiation surface has a vertical arm 1113a and a vertical arm 1113b that extend perpendicular to the radiation surface, and a length of each vertical arm is approximately 0.05λ₀. λ₀ is the wavelength of the electromagnetic wave at the center operating frequency of the first radiation assembly 11 when the electromagnetic wave propagates in free space. The vertical arm 1113a is disposed on the second polarized radiation arm 1112a, and the vertical arm 1113b is disposed on the second polarized radiation arm 1112b. The vertical arm 1113a and the vertical arm 1113b are disposed, so that the aperture of the radiation surface can be further reduced, and a size of the first radiator 111 in a direction parallel to the radiation surface can be reduced.

In another example, a quantity of disposed vertical arms, a location layout, and the like may be appropriately adjusted based on an actual requirement. Details are not described herein.

When the first director 112 is disposed, the first director 112 may have various structure types.

For example, as shown in FIG. 6, in an example provided in this application, the first director 112 is a metal sheet. To enable the resonant frequency of the first director 112 to fall within the range greater than or equal to 0.4F_{L} and less than or equal to 0.6F_{L}, an aperture L3*L4 of the radiation surface may be approximately 0.5λ_{L}*0.45λ_{L}. λ_{L} is a wavelength of an electromagnetic wave at the minimum operating frequency of the first radiation assembly 11 when the electromagnetic wave propagates in free space.

An edge of the first director 112 has a protrusion 1121a and a protrusion 1121b that are disposed opposite to each other. The protrusion 1121a and the protrusion 1121b are disposed, so that isolation of the first radiation assembly 11 in different polarizations can be effectively improved, to ensure performance of the first radiation assembly 11.

In addition, as shown in FIG. 6, in the example provided in this application, the first director 112 further has a slot 1122a and a slot 1122b. The slot 1122a and the slot 1122b are configured to implement decoupling of the first director 112 in different polarizations.

Refer to FIG. 5 and FIG. 6. The slot 1122a is provided corresponding to the first polarized radiation arm 1111a, and the slot 1122b is provided corresponding to the first polarized radiation arm 1111b. In a specific configuration, lengths of the slot 1122a and the slot 1122b may be greater than or equal to 0.15λ_{H} and less than or equal to 0.25λ_{H}. λ_{H} is a wavelength of an electromagnetic wave at the maximum operating frequency of the first radiation assembly 11 when the electromagnetic wave propagates in free space. The slot 1122a and the slot 1122b are provided, so that isolation of the first radiation assembly 11 in different polarizations can be effectively improved, to ensure performance of the first radiation assembly 11.

In another example, the slot 1122a may alternatively be provided corresponding to the second polarized radiation arm 1112a, and the slot 1122b may be provided corresponding to the second polarized radiation arm 1112b.

In a specific configuration, a size and a shape of the first director 112 may be appropriately set based on an actual requirement. In addition, parameters such as a quantity, shapes, and sizes of slots may also be appropriately set and adjusted based on an actual requirement. Details are not described herein.

In addition, in a specific configuration, to implement effective coupling between the first director 112 and the first radiator 111, a distance between the first radiator 111 and the first director 112 may be less than or equal to 0.1λ₀. λ₀ is the wavelength of the electromagnetic wave at the center operating frequency of the first radiation assembly 11 when the electromagnetic wave propagates in free space.

The distance between the first director 112 and the first radiator 111 is a distance between the first director 112 and the radiation surface of the first radiator 111. During specific application, a specific distance between the first director 112 and the first radiator 111 may be appropriately adjusted based on an actual requirement. Details are not described herein.

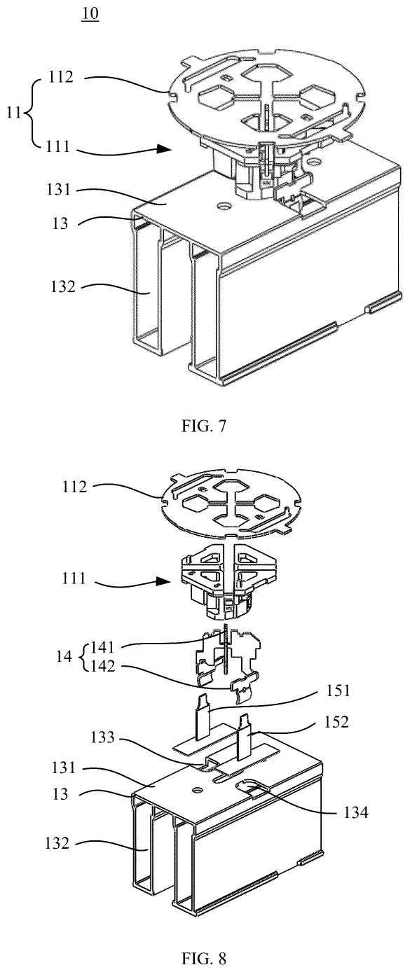

In addition, as shown in FIG. 7 and FIG. 8, in an example provided in this application, the antenna 10 further includes a reflective plate 13 and a balun structure 14. The reflective plate 13 has a reflective surface 131 and a back surface that is away from the reflective surface 131. Both the first radiation assembly 11 and the second radiator 12 are located on the reflective surface 131. The back surface of the reflective plate 13 has a feeding cavity 132. The feeding cavity 132 may provide effective mounting space for a feeding network (not shown in the figure).

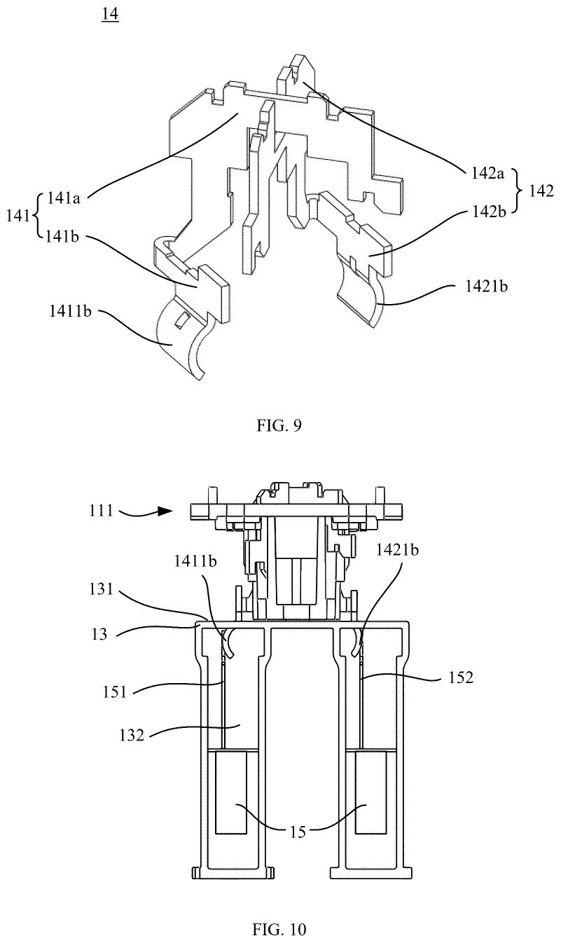

As shown in FIG. 8 and FIG. 9, in an example provided in this application, the balun structure 14 includes a first feeding plate 141 and a second feeding plate 142. The first feeding plate 141 has a first segment 141a and a second segment 141b, and an included angle that is in a direction parallel to the reflective surface 131 and that is between the first segment 141a and the second segment 141b is 45°. The second feeding plate 142 has a third segment 142a and a fourth segment 142b, and an included angle that is in the direction parallel to the reflective surface 131 and that is between the third segment 142a and the fourth segment 142b is 45°. The first segment 141a and third segment 142a are orthogonally disposed, to feed radiation arms that are orthogonally disposed in the first radiator 111. The second segment 141b and the fourth segment 142b are disposed in mirror symmetry, and an end portion of the third segment 142a and an end portion of the fourth segment 142b extend into the feeding cavity 132, to be connected to the feeding network in a vertically inserted manner.

As shown in FIG. 10, specifically, a feeding network 15 is located in the feeding cavity 132, and the feeding network 15 has a first feeding probe 151 and a second feeding probe 152. The end portion of the third segment 142a has a first arc-shaped arm 1411b, an outer arc surface of the first arc-shaped arm 1411b abuts against the first feeding probe 151, the end portion of the fourth segment 142b has a second arc-shaped arm 1421b, and an outer arc surface of the second arc-shaped arm 1421b abuts against the second feeding probe 152.

In addition, as shown in FIG. 8, to implement a connection between the balun structure 14 and the feeding network 15, the reflective surface 131 of the reflective plate 13 has a through hole 133 and a through hole 134 that run through the feeding cavity 132. The first arc-shaped arm 1411b of the first feeding plate 141 may pass through the through hole 133 into the feeding cavity 132, and abut against the first feeding probe 151. The second arc-shaped arm 1421b of the second feeding plate 142 may pass through the through hole 134 into the feeding cavity 132, and abut against the second feeding probe 152.

In addition, as shown in FIG. 11, in an example provided in this application, the first radiation assembly 11 may further include a second director 113. The second director 113 is located in the radiation direction of the first radiator 111 and coupled to the first radiator 111. A resonant frequency of the second director 113 may be near the maximum frequency of the first radiation assembly 11. For example, the resonant frequency of the second director 113 may be greater than or equal to 0.4F_{H} and less than or equal to 0.6F_{H}. F_{H} is the maximum operating frequency of the first radiation assembly 11.

The second director 113 is disposed, so that the maximum operating frequency of the first radiation assembly 11 can be achieved, to help increase bandwidth of the first radiation assembly 11. The second director 113 is coupled to the first radiator 111, so that an electromagnetic wave generated by the first radiator 111 can generate an induced current in the second director 113, and re-radiation of the induced current occurs in the second director 113, so that an electromagnetic wave in a high frequency band can be output, and bandwidth performance of the entire first radiation assembly 11 can be effectively ensured.

In a specific configuration, the second director 113 may have various structure types.

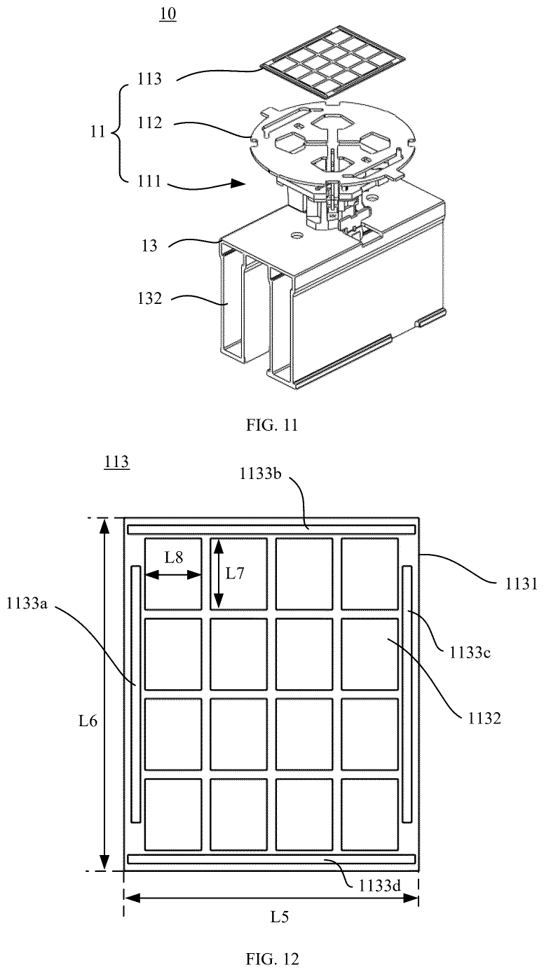

For example, as shown in FIG. 12, in an example provided in this application, the second director 113 includes a rectangular substrate 1131 and a plurality of rectangular sheets 1132 (where there are 16 rectangular sheets shown in FIG. 12), the rectangular substrate 1131 has a first plate surface (for example, an upper plate surface in FIG. 12), and the plurality of rectangular sheets 1132 are distributed on the first plate surface.

In a specific configuration, the substrate 1131 may be a substrate used to prepare a printed circuit board, or may be a substrate used to prepare a flexible circuit board. During actual application, a specific type of the rectangular substrate 1131 may be appropriately selected based on an actual requirement. This is not limited in this application. In addition, the rectangular sheet 1132 may be made of a material with good conductivity, such as copper or silver. The rectangular sheet 1132 may be specifically a metal plate disposed on the substrate 1131, or may be a metal coating directly formed on the substrate 1131.

In a specific configuration, a ratio of a width L5 to a length L6 of the rectangular substrate 1131 may be greater than or equal to 0.6 and less than 1. In other words, the rectangular substrate 1131 has an asymmetric structure, so that isolation of the first radiation assembly 11 in different polarizations can be effectively improved, to ensure performance of the first radiation assembly 11.

As shown in FIG. 12, in an example provided in this application, a size L7*L8 of each rectangular sheet 1132 may be approximately 0.06λ₀*0.045λ₀. λ₀ is the wavelength of the electromagnetic wave at the center operating frequency of the first radiation assembly 11 when the electromagnetic wave propagates in free space. In addition, the plurality of rectangular sheets 1132 are asymmetrically distributed on the first plate surface of the substrate 1131, so that isolation of the first radiation assembly 11 in different polarizations can be effectively improved, to ensure performance of the first radiation assembly 11.

It may be understood that, during actual application, a specific size of the rectangular substrate 1131 may be appropriately set based on an actual requirement. In addition, parameters such as a quantity, sizes, and a position layout of rectangular sheets 1132 included in the second director 113 may also be appropriately selected and adjusted based on an actual requirement. Details are not described herein.

In addition, as shown in FIG. 12, in an example provided in this application, the second director 113 further has four decoupling strips. The four decoupling strips are respectively a decoupling strip 1133a, a decoupling strip 1133b, a decoupling strip 1133c, and a decoupling strip 1133d. The four decoupling strips are all located on the first plate surface and disposed along an edge of the first plate surface. In the four decoupling strips, lengths of the decoupling strip 1133a and the decoupling strip 1133c are basically the same, lengths of the decoupling strip 1133b and the decoupling strip 1133d are basically the same, and a length of the decoupling strip 1133a is less than a length of the decoupling strip 1133b. In a specific configuration, a ratio of the decoupling strip 1133a to the decoupling strip 1133b maybe greater than or equal to 0.7 and less than 1. In summary, decoupling strips of different lengths are disposed in different polarizations, so that isolation of the first radiation assembly 11 in the different polarizations can be effectively improved, to ensure performance of the first radiation assembly 11.

In a specific configuration, the lengths of the decoupling strip 1133a and the decoupling strip 1133c may be approximately 0.2λ₀, and the lengths of the decoupling strip 1133b and the decoupling strip 1133d may be approximately 0.25λ₀, to achieve a good decoupling effect.

It may be understood that, during actual application, parameters such as a quantity, locations, and sizes of disposed decoupling strips may be appropriately selected and adjusted based on an actual requirement. Details are not described herein.

In a specific configuration, to implement effective coupling between the second director 113 and the first radiator 111, a distance between the first radiator 111 and the second director 113 may be greater than 0.1λ₀. λ₀ is the wavelength of the electromagnetic wave at the center operating frequency of the first radiation assembly 11 when the electromagnetic wave propagates in free space.

The distance between the second director 113 and the first radiator 111 is a distance between the second director 113 and the radiation surface of the first radiator 111. During specific application, a specific distance between the second director 113 and the first radiator 111 may be appropriately adjusted based on an actual requirement. Details are not described herein.

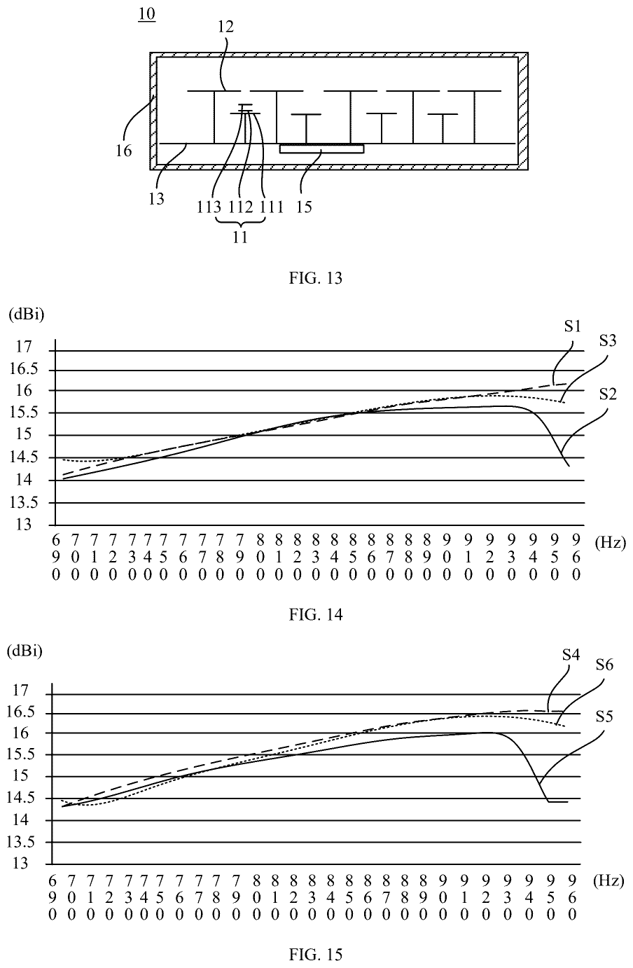

As shown in FIG. 13, when the antenna 10 is specifically disposed, the antenna 10 may include a plurality of first radiation assemblies 11 and a plurality of second radiators 12. Each first radiation assembly 11 may include a first radiator 111, a first director 112, and a second director 113. In addition, the antenna 10 may further include a radome 16, and the reflective plate 13 and the feeding network 15 that are located in the radome 16. The first radiator 111 and the second radiator 12 may be respectively connected to the feeding network 15 through corresponding balun structures.

During actual application, quantities and location layouts of first radiation assemblies 11 and second radiators 12 included in the antenna 10 may be appropriately set based on an actual requirement. This is not limited in this application.

In addition, as shown in FIG. 14 and FIG. 15, embodiments of this application further provide graphs of radiation gain versus frequency for the second radiator 12 in different cases. The second radiator 12 is of a dual-polarized type. FIG. 14 is a graph of radiation gain versus frequency for a polarization of the second radiator 12. FIG. 15 is a graph of radiation gain versus frequency for another polarization of the second radiator 12.

In FIG. 14 and FIG. 15, a horizontal coordinate represents the frequency in a unit of MHz, and a vertical coordinate represents the radiation gain in a unit of dBi. In addition, S1 and S4 represent data curves of radiation gain versus frequency for different polarizations of the second radiator 12 alone. S2 and S5 represent data curves of radiation gain versus frequency for different polarizations of the second radiator 12 after a conventional first radiator is disposed. S3 and S6 represent data curves of radiation gain versus frequency for different polarizations of the second radiator 12 after the first radiation assembly 11 provided in embodiments of this application is disposed.

It may be found through comparison that, after the conventional first radiator is disposed near the second radiator 12, the radiation gain of the second radiator 12 is significantly reduced. After the first radiation assembly 11 provided in embodiments of this application is disposed, impact of the first radiation assembly 11 (or the first radiator 111) on the second radiator 12 can be evidently reduced, so that the second radiator 12 has a good radiation gain.

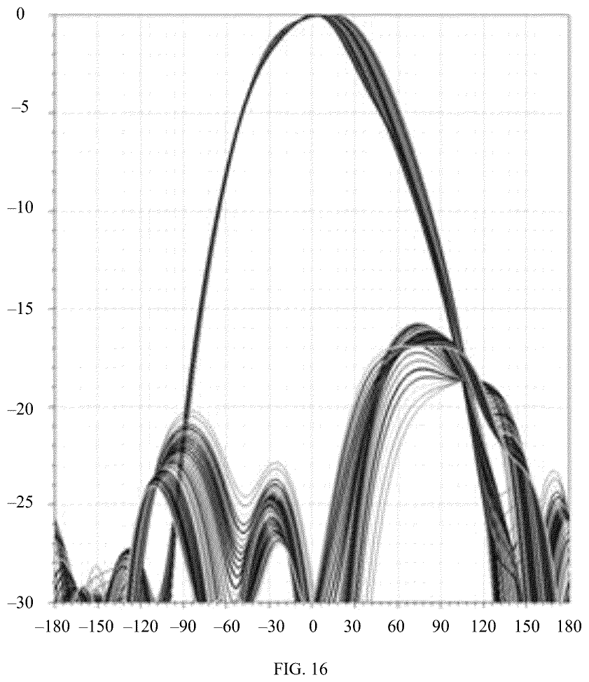

In addition, as shown in FIG. 16 to FIG. 18, embodiments of this application further provide radiation patterns of the second radiator 12 in different cases.

FIG. 16 shows a radiation pattern of a second radiator 12 alone. It may be learned that the radiation pattern is relatively convergent and smooth.

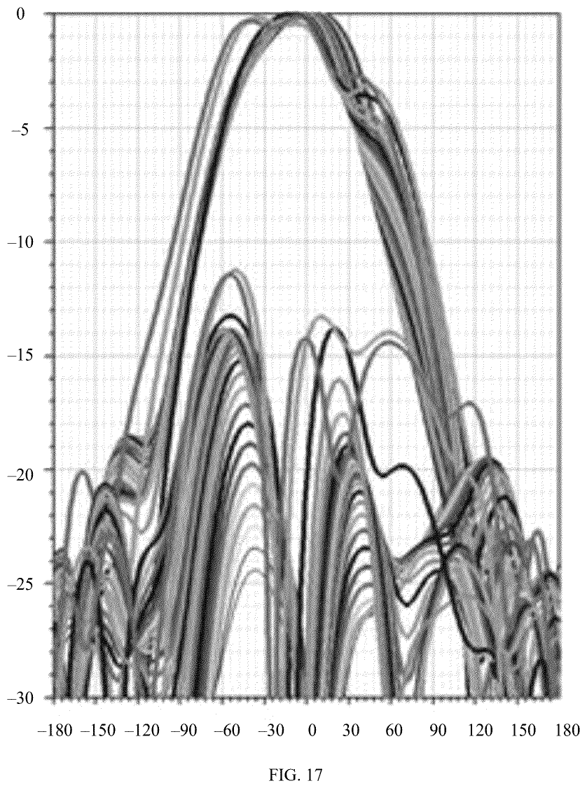

FIG. 17 shows a radiation pattern of the second radiator 12 after the conventional first radiator is disposed near the second radiator 12. It may be learned that the radiation pattern is evidently distorted.

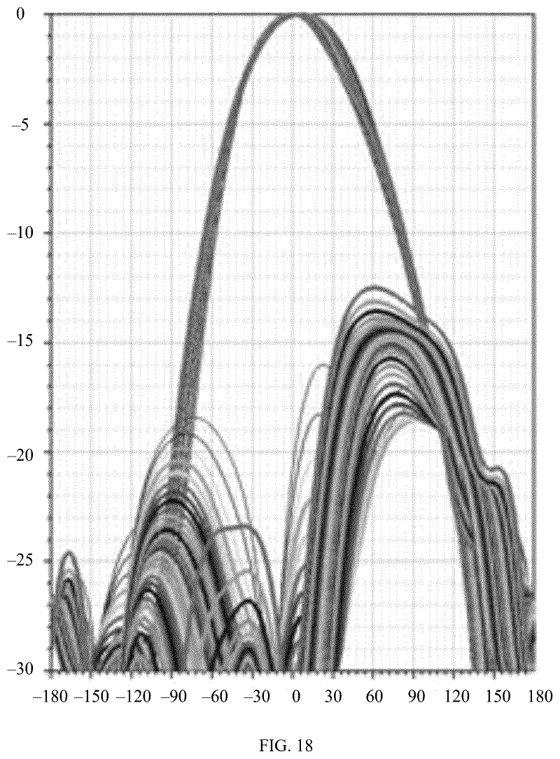

FIG. 18 shows a radiation pattern of the second radiator 12 after the first radiation assembly 11 provided in embodiments of this application is disposed near the second radiator 12. It may be learned that the radiation pattern is relatively convergent and smooth, which is similar to the radiation pattern in FIG. 16.

In application, a more convergent and smoother radiation pattern of the second radiator 12 indicates better operating performance of the second radiator 12, so that the operating performance of the second radiator 12 can be effectively ensured by using the first radiation assembly 11 provided in embodiments of this application.

During actual application, the antenna 10 may be used in a plurality of communication devices of different types.

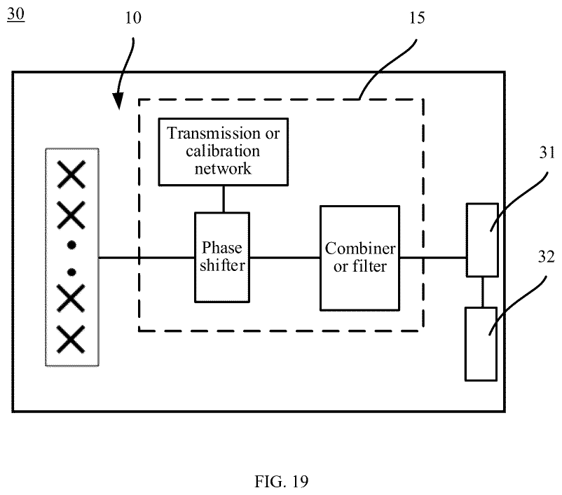

For example, as shown in FIG. 19, an embodiment of this application further provides a communication device 30, including any one of the foregoing antennas 10. The communication device may further include a radio frequency processing unit 31 and a baseband processing unit 32. The baseband processing unit 32 may be connected to the feeding network 15 of the antenna 10 through the radio frequency processing unit 31. The radio frequency processing unit 31 may be configured to: perform frequency selection, amplification, and down-conversion processing on a signal received by the antenna 10; convert the signal into an intermediate frequency signal or a baseband signal; and send the intermediate frequency signal or the baseband signal to the baseband processing unit 32. Alternatively, the radio frequency processing unit 31 is configured to: perform up-conversion and amplification processing on an intermediate frequency signal sent by the baseband processing unit 32; convert the intermediate frequency signal into a radio signal through the antenna 10; and send the radio signal. During actual application, a specific type of the communication device 30 is not limited in this application. In addition, types and a quantity of devices included in the communication device 30 may be appropriately selected and adjusted based on an actual requirement. Details are not described herein.

In embodiments of this application, unless otherwise stated or there is a logic conflict, terms and/or descriptions in different embodiments are consistent and may be mutually referenced, and technical features in different embodiments may be combined into a new embodiment based on an internal logical relationship thereof.

“A plurality of” in this application refers to two or more than two. “And/or” describes an association relationship between associated objects and indicates that three relationships may exist. For example, A and/or B may indicate the following cases: Only A exists, both A and B exist, and only B exists, where A and B may be singular or plural.

It may be understood that various numbers in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

What is claimed is:

1. An antenna, comprising a first radiation assembly and a second radiator, wherein an operating frequency band of the first radiation assembly is greater than an operating frequency band of the second radiator, and the first radiation assembly comprises:
a first radiator, wherein the first radiator has a radiation surface, an aperture of the radiation surface is greater than or equal to 0.25λ₀*0.25λ₀ and less than or equal to 0.35λ₀*0.35λ₀, a height of the first radiator in the radiation direction is less than or equal to 0.2λ_{L},
λ₀ is a wavelength of an electromagnetic wave at the center operating frequency of the first radiation assembly when the electromagnetic wave propagates in free space, and λ_{L} is a wavelength of an electromagnetic wave at the minimum operating frequency of the first radiation assembly when the electromagnetic wave propagates in free space; and
a first director, located in a radiation direction of the first radiator and coupled to the first radiator, wherein the first director has an radiation surface, an aperture L3*L4 of the radiation surface is 0.5λ_{L}*0.45λ_{L}.

2. The antenna according to claim 1, wherein the first radiation assembly further comprises a second director,
the second director is located in the radiation direction of the first radiator and coupled to the first radiator, a resonant frequency of the second director is greater than or equal to 0.4F_{H} and less than or equal to 0.6F_{H}, and
F_{H} is a maximum operating frequency of the first radiation assembly.

3. The antenna according to claim 2, wherein the radiation surface has a vertical arm that extends perpendicular to the radiation surface, a length of the vertical arm is 0.05λ₀, and
λ₀ is the wavelength of the electromagnetic wave at the center operating frequency of the first radiation assembly when the electromagnetic wave propagates in free space.

4. The antenna according to claim 1, wherein the first radiator has a first polarized radiation arm and a second polarized radiation arm that are orthogonally disposed;
the first director has a slot, and the slot is provided corresponding to the first polarized radiation arm or the second polarized radiation arm; and
a length of the slot is greater than or equal to 0.15λ_{H} and less than or equal to 0.25λ_{H}, and λ_{H} is a wavelength of an electromagnetic wave at the maximum operating frequency of the first radiation assembly when the electromagnetic wave propagates in free space.

5. The antenna according to claim 2, wherein the second director comprises a rectangular substrate and a plurality of rectangular sheets, the rectangular substrate has a first plate surface, the plurality of rectangular sheets are distributed on the first plate surface, and
a ratio of a width to a length of the rectangular substrate is greater than or equal to 0.6 and less than 1.

6. The antenna according to claim 5, wherein a size of each of the rectangular sheets is 0.06λ₀*0.045λ₀, and
λ₀ is the wavelength of the electromagnetic wave at the center operating frequency of the first radiation assembly when the electromagnetic wave propagates in free space.

7. The antenna according to claim 5, wherein the plurality of rectangular sheets are asymmetrically distributed on the first plate surface.

8. The antenna according to claim 5, wherein the second director further has a plurality of decoupling strips, the plurality of decoupling strips are all located on the first plate surface and disposed along an edge of the first plate surface, and
a ratio of a shortest decoupling strip to a longest decoupling strip among the plurality of decoupling strips is greater than or equal to 0.7 and less than 1.

9. The antenna according to claim 8, wherein the plurality of decoupling strips comprise a decoupling strip with a length of 0.2λ₀ and a decoupling strip with a length of 0.25λ₀.

10. The antenna according to claim 1, wherein the antenna further comprises a reflective plate and a balun structure,
the reflective plate has a reflective surface and a back surface that is away from the reflective surface, the first radiation assembly and the second radiator are both located on the reflective surface, and the back surface of the reflective plate has a feeding cavity;
the balun structure comprises a first feeding plate and a second feeding plate;
the first feeding plate has a first segment and a second segment, and an included angle that is in a direction parallel to the reflective surface and that is between the first segment and the second segment is 45°;
the second feeding plate has a third segment and a fourth segment, and an included angle that is in the direction parallel to the reflective surface and that is between the third segment and the fourth segment is 45°;
the first segment and third segment are orthogonally disposed, and the second segment and the fourth segment are disposed in mirror symmetry; and
both the first segment and the second segment are feed-connected to the first radiation assembly, and an end portion of the third segment and an end portion of the fourth segment extend into the feeding cavity.

11. The antenna according to claim 10, wherein the antenna further comprises a feeding network, and the feeding network is located in the feeding cavity;
the feeding network has a first feeding probe and a second feeding probe; and
the end portion of the third segment has a first arc-shaped arm, an outer arc surface of the first arc-shaped arm abuts against the first feeding probe, the end portion of the fourth segment has a second arc-shaped arm, and an outer arc surface of the second arc-shaped arm abuts against the second feeding probe.

12. A communication device, comprising a radio frequency processing unit and an antenna,
wherein the radio frequency processing unit is connected to a feeding network in the antenna, and
the antenna comprising a first radiation assembly and a second radiator, wherein an operating frequency band of the first radiation assembly is greater than an operating frequency band of the second radiator, and the first radiation assembly comprises:
a first radiator, wherein the first radiator has a radiation surface, an aperture of the radiation surface is greater than or equal to 0.25λ₀*0.25λ₀ and less than or equal to 0.35λ₀*0.35λ₀, a height of the first radiator in the radiation direction is less than or equal to 0.2λ_{L}, λ₀ is a wavelength of an electromagnetic wave at the center operating frequency of the first radiation assembly when the electromagnetic wave propagates in free space, and λ_{L} is a wavelength of an electromagnetic wave at the minimum operating frequency of the first radiation assembly when the electromagnetic wave propagates in free space; and
a first director, located in a radiation direction of the first radiator and coupled to the first radiator, wherein the first director has an radiation surface, an aperture L3*L4 of the radiation surface is 0.5λL*0.45λ_{L}.
